(19) United States
(12) Patent Application Publication
(10) Pub. No.: US 2006/0167761 A1
(43) Pub. Date: Jul. 27, 2006

(54) Method and apparatus for providing automated network reminders

(76) Inventors: Albert Fitzgerald Elcock, Havertown, PA (US); Thomas F. Kister, Chalfont, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/295,972

(22) Filed: Dec. 7, 2005

Related U.S. Application Data
(60) Provisional application No. 60/647,554, filed on Jan. 27, 2005.

(51) Int. Cl. G06Q 30/00

(52) U.S. Cl. 705/26

(57) ABSTRACT

At least one computer-readable medium encoded with instructions is provided which, when executed by a processor, performs a method including the steps of: receiving a message containing a notification from a vendor that provides a product or service to a customer; and forwarding the notification to a broadband terminal of the customer over a broadband communications system.

### STATEMENT OF RELATED APPLICATION

This application claims the benefit of U.S. Provisional Patent Application Ser. No. 60/647,554, filed Jan. 27, 2005, entitled “Automated Network Reminders,” which is incorporated by reference herein in its entirety.

### FIELD OF THE INVENTION

The present invention relates generally to a method and apparatus for providing automated network reminders, and more particularly to a method and apparatus for providing automated network reminders to a customer's set top terminal over a broadband communication system.

### BACKGROUND OF THE INVENTION

Failure to accurately remember to take medication is a very serious health problem, particularly for the elderly, for whom the taking of multiple medications is common. Often the appropriate efficacy levels of the medication are not reached or maintained, resulting in deterioration of health status and increased need of preventable hospital stays and medical procedures. Noncompliance, defined in medical parlance as the failure to follow through with therapy as prescribed by one's physician, is recognized as a significant impediment to improved health.

Many people, particularly among the elderly, are believed to be on an active medication regimen, typically taking multiple medications daily. It is believed that a significant portion of patients with illnesses do not comply with their medication regimen, with the elderly making up a significant portion of this population. A low rate of compliance with medication regimens results in a large number of hospitalizations and admissions to nursing homes every year, resulting in an escalation of medical costs for individuals and insurers, as well as an increase in preventable fatalities. The annual cost of noncompliance is estimated to exceed $100 billion.

There are many complex reasons why patients do not comply with their medication regimens. One major reason, for instance, relates to memory. A large number of persons who take medications, particularly those over 65 years of age, are believed to fail to comply with a prescribed regimen because of one or more of the following: (1) forgetting to take a medication, (2) forgetting to take a medication at the correct time, (3) forgetting the correct dosage, (4) forgetting important warnings and instructions that accompany the medications, (5) forgetting to refill a prescription, (6) forgetting to perform a health-related activity such as a therapeutic exercise or pulse reading, or (7) forgetting to attend their next doctor's appointment.

For the patient who must take three, four, or even five dosages of several medications daily, the prescribed regimens can easily become confusing. Many patients carry written timetables with them during the day. Pills are often set up in adjustable packets which can “line up” the medications to be taken. This can be effective, but does not solve the possibility of the patient becoming distracted or simply forgetful. More complex devices that use electronic technology to remind users when to take their medication are available and include electronic timers/alarms, medication dispensers combined with alarms, and fixtures for holding medication containers that are combined with alarms. Most of these devices require the users to program the device themselves. Furthermore, it is left up to the patient to remember to reprogram the device every time the regimen changes and to do so accurately.

There is thus a need for improved methods and apparatus for assisting a patient's memory with respect to timing, dosage, and counseling information relating to prescribed medications, as well as with respect to refilling prescriptions therefore.

### BRIEF DESCRIPTION OF THE DRAWINGS

FIG. 1 illustrates a broadband communications system over which a multi-service operator (MSO) provides programming or other content to a user.

FIG. 2 shows an example of a set top terminal.

FIG. 3 shows a functional block diagram of a server employed by the medication dispensing source shown in FIG. 1.

FIG. 4 is a flowchart illustrating one example of how a reminder message is communicated from the medication dispensing source to the customer's set top terminal.

### DETAILED DESCRIPTION

An ever-growing portion of the population spend much of their time viewing television. This is particularly true for the elderly, which is the same demographic group that has been found to have significant problems remembering to take medication. Accordingly, if messages reminding patients to take their medication could be automatically communicated to them over their television without the need for any action or intervention on the patient' part, compliance might be improved. As described herein, such reminders are sent to television viewers who receive broadcasts over a broadband communication system. Businesses such as pharmacies can forward reminder messages to their customer's set-top terminals over the broadband system so that they are displayed on the customer's television. The messages can remind the customers to take their medications at a certain time each day and/or to renew prescriptions. The messages may also include additional information such as medication interaction warnings, product updates and the like.

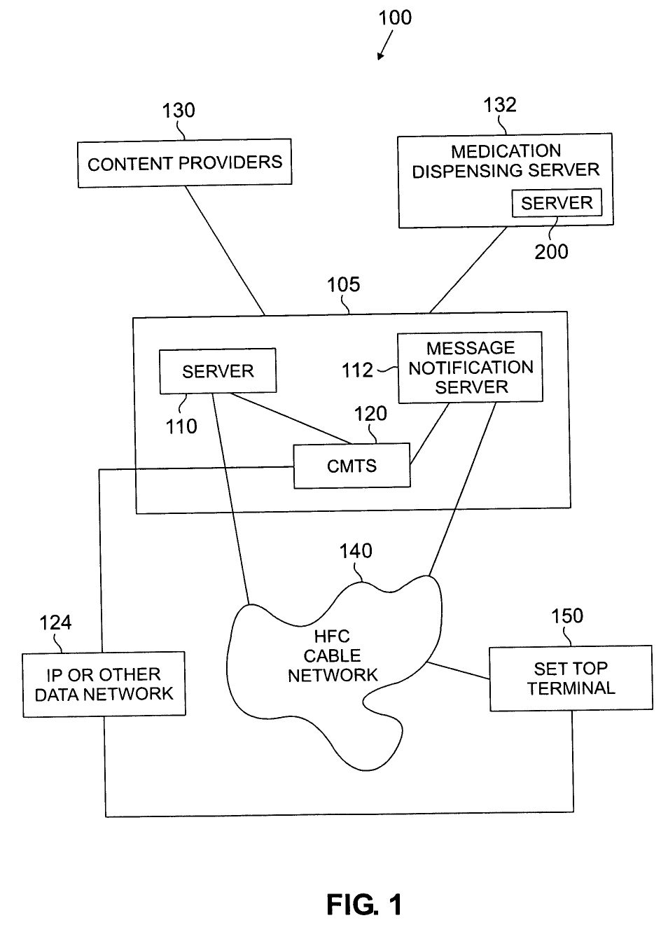

FIG. 1 illustrates a broadband communications system 100 over which a multiple system operator (MSO) provides programming or other content to a user. System 100 includes headend 105, hybrid fiber coax (HFC) cable network 140 and broadband terminals 150. In the case of cable network, the broadband terminals are set-top terminals 150. While broadband communications system 100 is depicted as employing a HFC cable network 140, the broadband system 100 more generally may be any public or private, wired or wireless, content transmission infrastructure or technology for delivery of content, including but not limited to a fiber-optic network, a coaxial cable network, a satellite network, a cellular network, a wireless network, the Internet, or any other transmission infrastructure or technology, or any combination thereof, operated by an MSO or any other type of broadband service provider, such as a television network or station, a studio, an Internet broadcaster or service provider, a cable operator, or a satellite operator. In the case of a satellite system, broadband terminal 150 is a satellite receiver.

Headend 105 receives content and services from various content providers such as content provider 130. Content providers 130 may provide content in digital or analog form. In addition, content providers 130 may supply executable code and data for application specific services. Analog and digital sources typically provide the traditional forms of television broadcast programs and information services. In general, the content that is supplied includes any pre-recorded or live electronic signals, either analog or digital, representing an image and/or audio, software, or other data, in any format. As further detailed below, one such content and service provider, denoted content provider 132 in FIG. 1, is not a traditional content provider that provides broadcasts and other content to users over the broadband communication system 100. Rather, content and service provider 132 is a pharmacy or other medication dispensing source that provides reminders and other messages to its customers over the broadband communications system.

Headend 105 processes content from one or more of the aforementioned sources in analog and digital forms. Analog program streams may be formatted according to the National Television Standards Committee (NTSC) or Phase Alternating Line (PAL) broadcast standard. Digital TV streams may be formatted according to the Digital Video Broadcasting (DVB), Society of Cable Telecommunications Engineers (SCTE), or Advanced Television Systems Committee (ATSC) standards. Among other things, headend 105 includes a server 110 that extracts program content in the analog and digital streams and reformats the content to form one or more encoded transport streams using, for example, MPEG-2. Server 110 represents one or more co-located or remote computer systems that may be implemented, for example, by a digital addressable controller (for example, Motorola's DAC 6000) and/or a remote addressable download server (such as Motorola's RADD 6000 or Carousel Server 1000). The transport streams generated by server 110 may be carried on one or more channels. For example, each channel may be 6 MHz bands populating a forward passband, e.g., 350-750 MHz band, of a coaxial cable, which is allocated for downstream communication from headend 105 to a set-top terminal. Upstream data from a set-top terminal is communicated via a reverse passband, e.g., 5-40 MHz band, of a coaxial cable. The reverse passband comprises reverse data channels (RDCs) having a 1 MHz bandwidth in this instance, through which signals containing upstream data are transmitted. It should be noted that the 1 MHz bandwidth allocated for an RDC here is for illustrative purposes only. It will be appreciated that a person skilled in the art may allocate other bandwidths therefor depending on the actual implementations.

In some cases broadband communications system 100 may offer advanced interactive cable services by implementing aspects of the “DOCSIS Set-top Gateway (DSG) Interface Specification,” published by CableLabs. on Aug. 4, 2004. In these cases headend 105 includes a data interface such as CMTS 120, which manages communications with a broadband (e.g., cable) modem located within set-top box 150. In accordance with the DSG Specification, CMTS 120 encapsulates IP datagrams received, for example, from packet-switched Network 124 into DOCSIS physical data units (“PDUs”), using a destination address that is uniquely associated with the cable modem. CMTS may be implemented, for example, by Motorola's BSR-64000 Broadband Services Router.

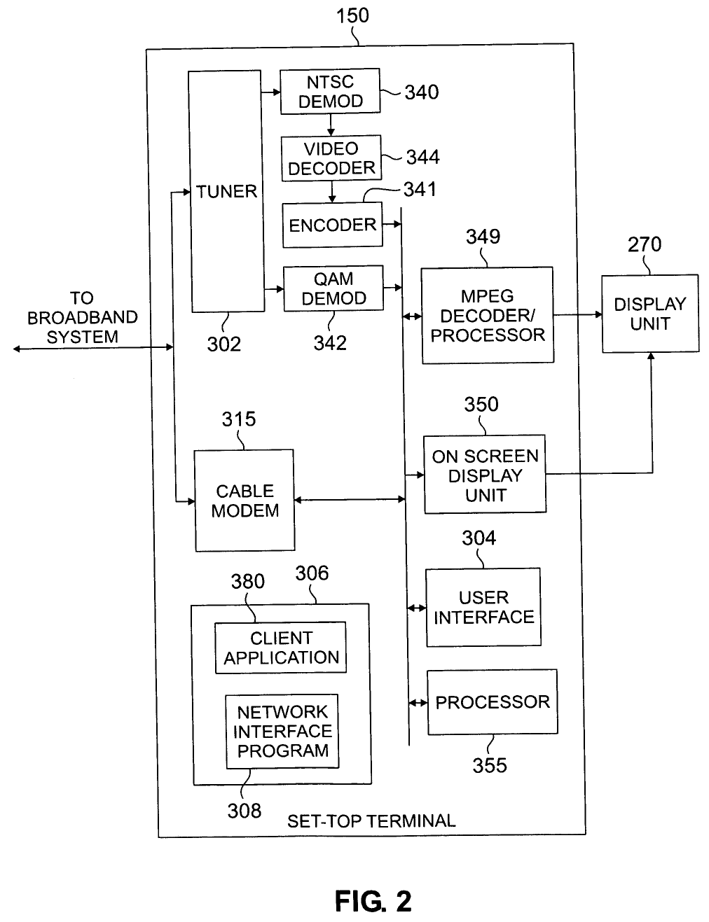

On the consumer side, one example of a set top terminal 150 is shown in more detail in FIG. 2. It should be noted that set top terminal 150 more generally may be any apparatus such as a hardware card, specially programmed computer or other device having the functionality described herein that may be placed near to or within a television or other display device (such as a computer monitor) such as display unit 270. The set top terminal 150 receives content from broadband communications system 100 seen in FIG. 1. Broadly speaking, a traditional set top terminal such as that depicted in FIG. 2 is a device that can receive, store and forward content without manipulating the content in any significant way except to format it so that it may be rendered in a suitable manner.

Set-top terminal 150 includes an in-band tuner 302, which tunes to a channel signal selected by a consumer (not shown) via user interface 304. User interface 304 may be any control device such as a remote control, mouse, microphone, keyboard, or display. NTSC Demodulator 340 and QAM Demodulator 342 are responsive to in-band tuner 302. NTSC Demodulator 340 includes components responsive to receive analog versions of a channel signal. A digital demodulator 342, which as shown is a QAM Demodulator, but, which may be any type of digital demodulator device, includes components responsive to receive digital versions of a channel signal, and to output video information. QAM Demodulator 342 receives and processes digital data packets from one or more digital sources, such as a digital television signal, an MPEG transport stream, or a media stream from an external network connection, such as cable modem 315 (if available), using well-known methods and techniques. Video decoder 344 is responsive to receive and decode video information. Video information that may require format translation or modification for compatibility with capabilities of set top terminal 150 may be passed to encoder 341 for formatting. Video information that is in a format preferred for use by MPEG Decoder/Multi Media Processor 349 may be passed directly to MPEG Decoder/Multi Media Processor 349. Encoder 341 is operative to perform predetermined coding techniques (for example, MPEG-2, MPEG-4, and others) to produce an encoded video signal for transmission to MPEG Decoder/Multi Media Processor 349, or for storage. MPEG Decoder/Multi-Media Processor 349 is operative to perform predetermined coding techniques to arrange video information into displayable formats, in accordance with well-known methods and techniques. Internal arrangements of MPEG Decoder/Multi-Media Processor 349 are well known, and may include analog-to-digital converters, one or more storage media and/or buffers, and general or special-purpose processors or application-specific integrated circuits, along with demultiplexers for demultiplexing and/or synchronizing at least two transport streams (for example, video and audio).

An on-screen display unit 350 is provided in set top terminal 150. The on-screen display unit 350 is used to display information such as control menus and the like as well as information received from the service provider or MSO that needs to be directly presented to the user regardless of the particular programming or channel that the user is currently viewing. Accordingly, on-screen display unit 350 can forward the information directly to the display unit 270, where it may appear as an overlay, pop up, or scrolling text ticker that is superimposed on the current programming being viewed. Alternatively, the information from the on-screen display unit 350 may even replace the current programming that appears on the display unit 270. As discussed below, the on-screen display unit 350 may be used to display the reminder messages received from a content provider (such as medication dispensing source 132 in FIG. 1) either directly or indirectly via the headend 105 of the broadband service provider or MSO.

Set-top terminal 150 further includes a computer-readable storage medium 306. Computer-readable storage medium 306 may be any local or remote device capable of recording or storing data, and in particular may be, or may include, a read only memory (“ROM”), flash memory, random access memory, a hard disk drive, all types of compact disks and digital videodisks, and/or magnetic tape. Various application programs may reside on storage medium 306. The applications residing on storage medium 306 (as well as other applications discussed below such as in connection with medication dispensing source 132 and headend 105) may be computer programs that include software components implemented according to well-known software engineering practices for component-based software development and stored in computer-readable memories, such as storage medium 306. The applications, however, may be any signal processing methods and/or stored instructions, in one or more parts, that electronically control functions set forth herein. Storage medium 306 may also include other programs to provide additional functionality. For example, a network interface program 308 may be provided that represents aspects of the functional arrangement of various computer programs that pertain to the receipt and processing of content and other data over the broadband system 100.

As previously mentioned, set-top terminal 150 may include an embedded broadband modem such as a cable modem 315 that communicates with a data interface such as CMTS 120 located in headend 105 for providing interactive data services to the user. Cable modem 315 may be, for example, a DOCSIS-compliant cable modem that includes DSG Protocol functionality for converting signals received over HFC cable network 140 into data packets for receipt by set-top terminal 150.

The various components of set top terminal 150 discussed above may all operate under the overall control of a processor 355.

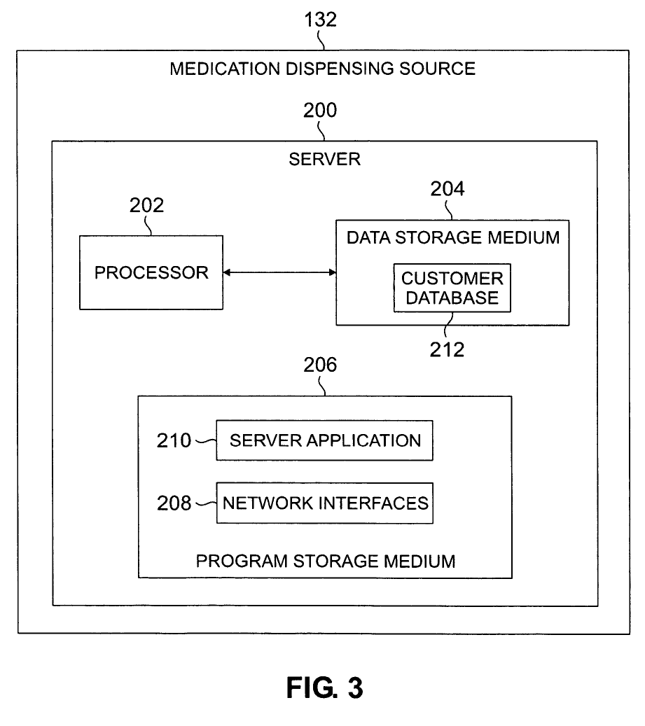

FIG. 3 shows a functional block diagram of a server 200 employed by the medication dispensing source 132 shown in FIG. 1. A processor 202 is responsive to computer-readable data storage medium 204 and to program storage medium 206. A customer database 212 is stored on data storage medium 204 that includes, for instance, a list of customers, their addresses and other contact information, the medications they have received from the dispensing source 132, an insurer's name, and other pertinent information associated therewith. Many medication dispensing sources such as pharmacies and mail-order drug dispensers often have all or part of such an electronic database already available. For those customers who wish to receive reminder messages from the dispensing source 132, another identifier is added to the database. This identifier, discussed in more detail below, serves as an address at which the customer can be reached, directly or indirectly, through his or her set-top terminal over the broadband communications system 100.

A server application 210 residing on program storage medium 206 is used to access the customer database 212. The server application 210 identifies upcoming dates in the customer database 212 of which a customer should be made aware, such as the date by which a medication prescription needs to be refilled. Once an upcoming date is identified, the customer's name, identifier, and pertinent information concerning the reason for the notification is extracted from the customer database 212 by the server application 210. The application then formats the information in an appropriate format so that it can be communicated to the customer over the broadband system 100. The manner in which the information is formatted will depend in part on the type of identifier or address the customer provides to the medication dispensing source 132, which in turn depends on the functionality offered by the customer's set-top terminal. For instance, if the set-top includes a broadband modem (e.g., cable modem 315), the identifier can be the destination address of the broadband modem such as an IP or other network address, in which case the message can be transmitted to the customer in the form of an e-mail or the like.

On the other hand, if the customer's set top terminal does not include a broadband modem, one other identifier the customer may be able to provide the medication dispensing source 132 for storage in customer database 212 is the identity (e.g., a name and network or other electronic address) of the customer's broadband service provider. In this case the medication dispensing source 132 will need to indirectly communicate the reminder message to the customer with the cooperation of the customer's broadband service provider. For instance, the medication dispensing source 132 may have an agreement with a number of different service providers to collectively offer such reminder notification services to their mutual customers. That is, in one illustrative system the vendor sends the customer name (or other identifier) and the message to the broadband service provider or MSO, which then uses the customer name or other identifier to locate the address of the customer's set top terminal address. The broadband service provider or MSO then forwards the message to the customer at that address.

With such an arrangement in place, the medication dispensing source 132 can forward the reminder message to the customer's broadband service provider or MSO over the broadband network 140, data network 124 or by any other means using an appropriate electronic address of the service provider or MSO. The broadband service provider, in turn can access a lookup table or other database that contains the customer's name along with the unit or mac address of the customer's set top terminal. For instance, in FIG. 1, the reminder message can be received at the headend 105 of the broadband service provider. The lookup table or database, which may be located in a server associated with headend 105 such as message notification server 112, identifies those customers who have requested that they receive reminder messages from their medication dispensing source. The service provider can then forward the message to the customer using the unit or mac address of the set top terminal.

Regardless of whether the customer receives the reminder message at the destination address of his or her broadband modem or at the unit or mac address of the set-top terminal itself, a client application 380 residing on storage medium 306 can be used to access the message. Depending on the message format, the application 380 may direct the message to encoder 341 or QAM demodulator 342 before being passed to MPEG decoder/multi media processor 349 for processing in a format displayable on the display unit 270.

It should be noted that the reminder message may be communicated to the client in either a push or pull manner. In a typical client/server environment involving a pull, the client engages a server with a request for service or information. The server responds to the request and returns information to the client. This interaction is referred to as a pull, since the customer is effectively pulling information from the server. An example of a typical pull is searching a search engine on the Internet. In this example, the client transmits a search string to the server, which responds with a list of matching elements. In the present case, the customer (the client) may use the set top terminal 150 to request that the reminder messages be forwarded from either the broadband service provider's server 110 or the medication dispensing server 132, depending on the particular configuration that is employed.

In a push interaction, the server transmitting information to the client without explicit instruction from the client to do so. This interaction is referred to as a push, since the server is effectively pushing information to the client. A good example of a typical push is the frequent transmission of a weather forecast, news headline, or stock quote. The server runs software that is configured to record the weather forecast, news headline, or stock quote at predetermined intervals and automatically transmit updates to the client. Accordingly, even though the client is not requesting the information at these intervals, the information is transmitted from the server. In the present case, the reminder messages may be automatically transmitted to the customer's set top terminal 150 (the client) by either the broadband service provider's server 110 or the medication dispensing server 132, depending on the particular configuration that is employed. In a push interaction, the reminder message received by the customer's set-top terminal may be stored in a memory (e.g., storage medium 306) until accessed by the customer upon activation of the set-top terminal when beginning a viewing session, at which time the on-screen display unit may automatically transmit the message to the display unit 270. If the set-top terminal includes a distinct electronic storage medium that serves as a personal video recorder, the reminder message may be stored on it.

As an alternative to communicating the messages in a push or pull manner, the messages may be transmitted by the server in the form of a calendar. The calendar may be, for example, a weekly or monthly calendar that includes all the reminder messages that are to be communicated over the period of time covered by the calendar. An application residing on the set top terminal 150 receives the calendar and retrieves the individual messages on the appropriate date and time. Accordingly, the server only needs to transmit an updated calendar to the set top terminal over the period of time covered by the calendar whenever one or more of the reminders is to be changed. This approach reduces the number of individual messages that must be transmitted from the server to the set top terminal.

Depending on customer preference and/or the capabilities of the client application 380, the message may be presented to the customer on display unit 270 in a variety of different forms, such as a pop-up, overlay, or a scrolling text ticker. In some cases other user devices (e.g., personal computers, data terminal equipment, telephones, media players, networked consumer appliances, cellphones, pagers or PDAs) may be in communication with the set-top terminal, either directly or over a data network such as a local area network (LAN) or a wide are network (WAN). If available, the reminder message may be forwarded to one or more of the user devices instead of, or in addition to, displaying the message on display unit 270. For example, if a telephone is connected to the set top terminal, a call can be placed from the set top to the customer over the telephone using, for instance, a synthesized voice message to communicate the message. If the message is displayed on display unit 270, the customer will generally be given an opportunity to remove the message using the user interface 304. For example, the customer may be asked to press a predetermined button on a remote control to remove the message.

The reminder messages that are sent to customers may be sent at different intervals of time, depending on the nature of the message. For example, a reminder from a medication dispensing source to renew a prescription may be sent on a monthly or quarterly basis, depending on the period of time that the prescription covers. On the other hand, some messages such as a reminder to take a certain medication may be sent daily (if the medication is to be taken daily), twice daily (if the medication is to be taken twice daily) or even hourly in some cases. The interval of time between messages will determine in part the useful lifetimes of the messages in which they must be received and communicated to the customers. That is, a daily reminder message is of no value if it is received and viewed by the customer a day or more late, at which point another daily reminder has presumably been sent. Likewise, a reminder message that is to be sent twice daily, perhaps once in the morning and once in the evening, is of little value if it is only received and viewed by the customer after the next reminder is already sent. Accordingly, in some cases the messages may incorporate an expiration time, after which the message will be automatically removed from the server if it has not been downloaded by the customer (in a pull type configuration) or it automatically removed from the set-top terminal (in a push type configuration). In this way the customer does not have sort through multiple messages that are no longer of value to him or her.

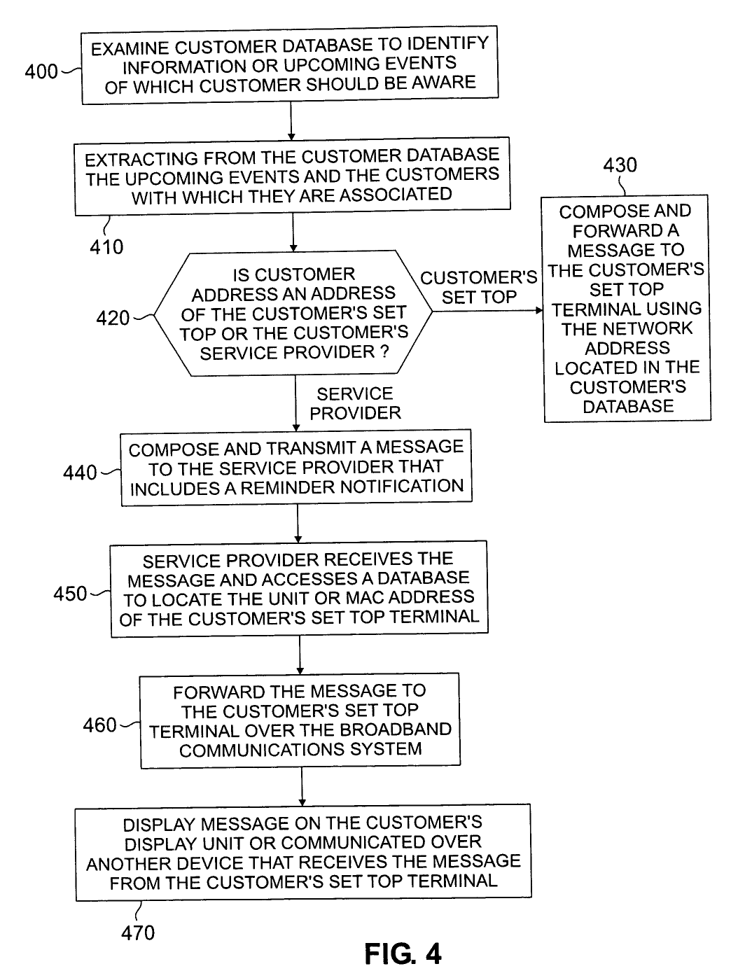

FIG. 4 is a flowchart illustrating one example of how a reminder message is communicated from the medication dispensing source 132 to the customer's set top terminal. The method begins in step 400, in which a database associated with the medication dispensing source 132 is queried to identify information or upcoming events of which its customers should be aware. Such queries may be automatically performed on any periodic basis (e.g., daily, hourly). Since, as previously mentioned, different reminder information that is to be extracted from the database may have different useful lifetimes, the queries should generally be performed on a time frame that is less than the useful lifetimes of the information. For example, information of which the customer should be reminded daily (and hence has a useful lifetime of one day) should be queried on a time frame less than a day. Likewise, information of which the customer should be reminded weekly (and hence has a useful lifetime of one week) should be queried on a time frame less that is less than weekly. Alternatively, the queries may be manually initiated when, for instance, an individual activates an application program that resides on the medication dispensing source's server. The queries performed by the medication dispensing source may be performed in one or more batch processes at predetermined times of the day. For example, information that needs to be forwarded to the customer once daily could be queried at one predefined time each day, while information that needs to be forwarded to the customer monthly could be queried at a predefined day and time each week. Batch processing may be used with reminder messages that are sent in either a push or pull configuration.

Continuing with step 410 the information or upcoming events that have been identified are extracted from the database, along with the address of the customer to which the information pertains. Depending on whether the customer's address that is retrieved is the customer's set top terminal address or the address of the customer's broadband service provider (step 420), a message containing the information is either forwarded to the customer's set top terminal (step 430) or to the broadband service provider (step 440). An example of a message may include such things as the customer's name and a short description of the action the customer needs to take (e.g., take medication, refill a prescription). If the service provider receives the message, then in step 450 the service provider accesses its own customer database to locate the unit or mac address of the customer's set top terminal. Then, in step 460, the service provider forwards the message to the customer's set top terminal over the service provider's broadband communication system. Once the message has been received by the customer's set top terminal, either from the service provider or the medication dispensing source itself, in step 470 the message is displayed on the customer's display unit 270 by on-screen display unit 350 or, as previously mentioned, communicated over another device that receives the message from the customer's set top terminal. If the message is to be displayed on the display unit 270, it may be presented as an overlay, pop up, or scrolling text ticker that is superimposed on the current programming being viewed. Alternatively, the message from the on-screen display unit 350 may replace the current programming that appears on the display unit 270. As previously mentioned, regardless of how it is displayed, the customer may be given the opportunity to delete or otherwise remove the message from the display unit 270.

The processes described above in connection with the set-top terminal 150, the headend 105, and the server 200 each may be implemented in general, multi-purpose or single purpose processors respectively associated with the set-top terminal 150, the headend 105, and the server 200. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Although various embodiments are specifically illustrated and described herein, it will be appreciated that modifications and variations of the present invention are covered by the above teachings and are within the purview of the appended claims without departing from the spirit and intended scope of the invention. For example, while the above systems and methods have been described in terms of reminder or other messages that are communicated to a customer of a medical dispensing source, the systems and methods more generally could be used by any vendor of goods or services to send a variety of different types of messages to its customers. For example, an automotive dealer could send notices to its customers reminding them that their automobiles are due for service. As used herein the term vendor refers to any person, organization or business other than the broadband service provider or MSO which has a pre-established relationship with the customer. Accordingly, a vendor may include, without limitation, schools, school districts, government organizations, religious institutions, as well as commercial purveyors of goods and services. The nature of the reminder message will depend on the particular vendor. For instance, if the vendor is a school, one example of a reminder message that may be sent to the customer is a reminder to pick up a child at an earlier than usual because of early dismissal. Moreover, the systems and method described herein may also be used by parties other than vendors to send reminder messages. For example, the same arrangement could be used by one spouse to send a reminder message to another spouse reminding him or her, for example, to pick up their child from school on a particular day.

1. At least one computer-readable medium encoded with instructions which, when executed by a processor, performs a method including the steps of:
receiving a message containing a notification from a vendor that provides a product or service to a customer; and
forwarding at least the notification to a broadband terminal of the customer over a broadband communications system.

2. The computer-readable medium of claim 1 wherein the message is forwarded to a network address of a broadband modem associated with the broadband terminal.

3. The computer-readable medium of claim 1 wherein the notification is forwarded to a unit or mac address of the broadband terminal.

4. The computer-readable medium of claim 3 wherein the message includes an identifier element identifying the customer and further comprising the step of accessing a database to obtain the unit or mac address of the broadband terminal associated with the customer using the identifier element.

5. The computer-readable medium of claim 1 wherein the notification is forwarded to the broadband terminal in a format suitable for display on a display device in operative communication with the broadband terminal.

6. The computer-readable medium of claim 1 wherein the notification pertains to the product or service previously obtained by the customer from the vendor.

7. The computer-readable medium of claim 1 wherein the vendor is a medication dispensing source.

8. The computer-readable medium of claim 7 wherein the notification includes a reminder to refill a prescription for medication.

9. The computer-readable medium of claim 7 wherein the notification includes a reminder that the customer needs to take medication.

10. The computer-readable medium of claim 8 wherein the notification further includes additional information concerning the prescription.

11. The computer-readable medium of claim 1 wherein the message is received by a headend of the broadband communications system.

12. The computer-readable medium of claim 1 wherein the broadband terminal is a set top terminal.

13. The computer-readable medium of claim 1 wherein the broadband terminal is a satellite receiver.

14. The computer-readable medium of claim 1 wherein the vendor is selected from the group consisting of schools, school districts, government organizations, religious institutions and commercial purveyors of goods and services.

15. The computer-readable medium of claim 1 further comprising the step of receiving a second message containing a notification from another party and forwarding the second message to the broadband terminal.

16. The computer-readable medium of claim 1 wherein the message is included in a calendar of one or more reminders that is forwarded to the broadband terminal.

17. At least one computer-readable medium encoded with instructions which, when executed by a processor, performs a method including the steps of:
accessing a customer database to identify select information to be communicated to a customer;
extracting from the database the select information and an identifier used to forward the select information to the customer over a broadband communications system for receipt by a broadband terminal of the customer; and
forwarding the select information in accordance with the identifier.

18. The computer-readable medium of claim 17 wherein the identifier comprises an electronic address of a broadband service provider that provides service to the customer over the broadband communications system such that the select information is forwarded to the broadband service provider.

19. The computer-readable medium of claim 17 wherein the identifier is a unit or mac address of the broadband terminal.

20. The computer-readable medium of claim 19 wherein the message includes an identifier element identifying the customer and further comprising accessing a database to obtain the unit or mac address of the broadband terminal associated with the customer using the identifier element.

21. The computer-readable medium of claim 18 wherein the notification is forwarded to the broadband terminal in a format suitable for display on a display device in operative communication with the broadband terminal.

22. The computer-readable medium of claim 21 wherein the notification pertains to the product or service previously obtained by the customer from a vendor.

23. The computer-readable medium of claim 17 wherein the vendor is a medication dispensing source.

24. The computer-readable medium of claim 17 wherein the broadband terminal is a set top terminal.

25. A set-top terminal comprising:
a receiver/tuner for receiving content on any of a plurality of channels over a broadband communications network;
a decoder for decoding the content provided by the receiver/tuner;
an on-screen display unit for displaying information on a display regardless of a channel to which the receiver/tuner is currently tuned and regardless of any content otherwise being displayed;
a processor operationally associated with the receiver/tuner, the decoder, and the on-screen display unit;
a user interface operationally associated with the processor; and
wherein the processor is configured to:
receive a message containing a notification from a vendor that provides a product or service to a broadband communications subscriber; and
forward at least the notification to the on-screen display unit such that the notification is displayable on the display regardless of any content currently being displayed.

26. The set-top terminal of claim 25 further comprising a broadband modem and wherein the message is forwarded to a network address of the broadband modem.

27. The set-top terminal of claim 25 wherein the message is forwarded to a unit or mac address of the set top terminal.

28. The set-top terminal of claim 25 wherein at least the notification is also forwarded by the processor to an external device other than the display in communication with the set-top terminal for receipt by the customer.

29. The set-top terminal of claim 28 wherein the external device is selected from the group consisting of personal computers, data terminal equipment, telephones, media players, networked consumer appliances, cellphones, pagers and PDAs.
